(19) United States
(12) Patent Application Publication
(10) Pub. No.: US 2014/0023817 A1
(43) Pub. Date: Jan. 23, 2014

(54) Wear Resistant Thermoplastic Copolyester Elastomer

(71) Applicant: Ticona LLC, Florence, KY (US)

(72) Inventors: Mukul Kaushik, Florence, KY (US); Dirk Zierer, Hofheim (DE); Deiwes Jose Rigoletti Orloski, Araraquara (BR); Suzanne Renee Redding, Florence, KY (US); Simone Pereira Orosco, Sao Paulo (BR); Guert Ruecker, Sao Paulo (BR)

(73) Assignee: Ticona LLC, Florence, KY (US)

(21) Appl. No.: 13/945,444

(22) Filed: Jul. 18, 2013

Related U.S. Application Data
(60) Provisional application No. 61/787,063, filed on Mar. 15, 2013.
(60) Provisional application No. 61/672,969, filed on Jul. 18, 2012.

(51) Int. Cl. C08L 67/03; C09D 167/03

(52) U.S. Cl. CPC C08L 67/03; C09D 167/03
USPC 428/66.1; 525/177; 525/165; 525/173; 524/513; 442/105; 428/480; 428/66.4; 428/64.1

(57) ABSTRACT

An elastomeric polymer composition is disclosed that is wear resistant at a broad range of temperatures. The composition contains a thermoplastic elastomer, such as a thermoplastic polyester elastomer, that forms a polymer matrix in products made from the polymer composition. The polymer composition may also contain a fluoropolymer and/or unmodified or functionalized ultra-high molecular weight polyolefin particles, such as ultra-high molecular weight polyethylene particles.

### RELATED APPLICATIONS

This application claims filing benefit of U.S. Provisional Patent Application Ser. No. 61/787,063, filed on Mar. 15, 2013, and U.S. Provisional Patent Application Ser. No. 61/672,969, filed on Jul. 18, 2012, and which are both incorporated herein in their entirety.

### BACKGROUND

Thermoplastic elastomers are a class of useful materials that have a unique combination of properties. The materials, for instance, can be formulated so as to be flexible and tough, while having elastic characteristics. Of particular advantage, the materials can also be melt processed due to their thermoplastic nature. In addition, the materials can be reground and recycled for further use unlike other materials such as crosslinked rubbers.

Thermoplastic elastomers are used in numerous applications. The materials, for instance, may be molded to form a particular part or product or may comprise a component in a product. Due to their flexible and elastic nature, thermoplastic elastomers are commonly used in applications where the material constantly undergoes deformation or otherwise contacts other moving parts. One problem faced by those skilled in the art has been the ability to improve the wear resistant properties of thermoplastic elastomers. Commonly available elastomers, for instance, typically have a narrow temperature window of conditions within which the materials have acceptable wear resistant properties. Thermoplastic polyurethane elastomers, for instance, are known to undergo changes in their physical properties as the temperature changes.

In view of the above, an ongoing need exists for a thermoplastic elastomer that has improved wear resistant properties. In particular, a need exists for a thermoplastic elastomer that has wear resistant properties over a broad range of temperatures. A need also exists for a method of improving the wear resistant properties of a thermoplastic elastomer without adversely changing or altering the underlying properties of the material.

### SUMMARY

In general, the present disclosure is directed to polymer compositions containing primarily a thermoplastic elastomer that have improved abrasion resistance while maintaining the desired physical properties of the thermoplastic elastomer. Of particular advantage, the polymer compositions of the present disclosure can be tailored to a particular end use application. For instance, the polymer composition can be formulated so as to have a desired flexural modulus in combination with wear resistance. In addition, the polymer composition can be formulated so as to have desired physical properties over a wide temperature range in comparison to thermoplastic elastomers used in the past, such as thermoplastic polyurethane elastomers.

In one embodiment, for instance, the present disclosure is directed to a polymer composition and to various products produced from the composition. The polymer composition contains a thermoplastic elastomer, and particularly a thermoplastic polyester elastomer. The thermoplastic elastomer is present in the composition in an amount sufficient to form a polymer matrix phase. Distributed throughout the matrix phase is a wear resistant additive. In one embodiment, for instance, the wear resistant additive comprises ultra-high molecular weight polyethylene particles. The particles form a minor phase within the matrix phase. The ultra-high molecular weight polyethylene particles may include a functionalized surface. When present, the functionalized surface allows for interfacial bonding to occur between the thermoplastic elastomer and the particles. In one embodiment, the functionalized surface on the particles is produced by plasma treating the particles. In one embodiment, for instance, the wear resistant additive comprises a fluoropolymer. In one embodiment, for instance, the wear resistant additive comprises a combination of a fluoropolymer and ultra-high molecular weight polyethylene particles.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a cross-sectional view of a washing machine that may include components made from the polymer composition of the present disclosure;

FIG. 2 is a cross-sectional view of a homokinetic joint that may include components made from the polymer composition of the present disclosure;

FIG. 3 is a side view of a boot, such as a motorcycle boot, that may be made in accordance with the present disclosure;

FIGS. 4 and 5 are perspective views of portions of a vehicle that include gaskets made in accordance with the present disclosure;

FIG. 6 is a perspective view of a portion of a shock absorber that includes seal rings made in accordance with the present disclosure; and

FIG. 7 is a perspective view of a portion of a gear made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to polymer compositions that contain a thermoplastic elastomer combined with a wear resistance additive. Polymer compositions made according to the present disclosure are generally flexible and can have elastic properties. More particularly, the polymer compositions of the present disclosure can be formulated so as to have the physical properties of a thermoplastic elastomer while having improved abrasion resistance. Of particular advantage, the above desired properties may exist over a wide temperature range. In addition, the polymer compositions can be formulated so as to have a relatively low density in relation to a relatively high specific strength. Consequently, lighter articles can be designed having thinner walls.

Polymer compositions made in accordance with the present disclosure can be used in numerous and diverse applications. The polymer composition, for instance, can be used as a coating on a surface. Alternatively, various articles and products can be produced exclusively from the polymer composition. For example, the polymer composition can be molded into any suitable shape using, for instance, injection molding. Polymer compositions made according to the present disclosure, for instance, can be used to produce hoses, bumpers, pads, pulley and pulley components, conveyor belt segments, other conveyor belt parts, and toys and toy components. The polymer composition can be used to produce gaskets, O-rings, sheet stock for seals/gaskets, washers, gears, and seals including, but not limited to, hydraulic piston seals and suspension seals such as damper seals that provide a long term sealing performance even in a harsh environment. The polymer composition according to the present disclosure enables a reduction a wall-thickness without compromising tear and fatigue resistance. In addition, the additional step of applying a grease, oil, or lubricant may not be necessary and the composition may still provide a lesser noise during operation.

The polymer compositions can be used to produce sports equipment, packaging materials, window panels, household goods, furniture parts, optical devices, decorative pieces, and the like. The polymer composition can be used to produce automotive parts such as door latch claws and pawls. The polymer composition can also be incorporated into protective soft touch housing for electronic devices such as tablet covers, flexible mouse, joysticks, cellphones, telephones, gaming consoles, and the like. The polymer composition can be used for components related to paper and receipt conveying such as ATMs, check sorting apparatus, and a credit card feeder and/or reader, and the like. The polymer composition can be used in conveyor systems that must be durable, non-slip, and smooth running with maximum pulling power. In addition, the polymer composition can be used in applications where a resistance to oils, fuels, most chemicals, or acids with a moderate pH is desired. In addition, the polymer composition can be used in other applications due to the high flexibility with excellent tear resistance, the electrical insulation properties, and a lower propensity to ozone attack.

Of particular advantage, the polymer composition can also be formulated so as to be substantially rigid and can have acoustic dampening properties. In one embodiment, for instance, the polymer composition can be incorporated into partitions that provide acoustic dampening.

In general, the polymer composition of the present disclosure contains a thermoplastic elastomer combined with a wear resistance additive, which may comprise a fiuoropolymer, polyolefin particles, particularly ultra-high molecular weight polyethylene particles, or a combination thereof. The thermoplastic elastomer can be present in the composition in an amount sufficient to produce a matrix phase. The matrix phase exhibits the properties of the thermoplastic elastomer such as flexibility, strength and elasticity. The wear resistant additive forms a minor phase and is dispersed throughout the thermoplastic elastomer and the matrix phase.

In one embodiment, the impact resistance additive includes functional groups or is otherwise surface treated. In this manner, interfacial bonding can occur between the wear resistant additive and can form interfacial bonding with the thermoplastic elastomer, especially when the thermoplastic elastomer comprises a thermoplastic polyester elastomer. In order to further enhance interfacial bonding, in one embodiment, a reactive impact modifier may also be included in the formulation.

As stated above, various different types of articles and products may be made from the polymer composition. Since the polymer composition is thermoplastic in nature, the composition can be molded into any suitable shape. Freestanding articles can be produced from the polymer composition or the polymer composition can form a coating or component on or in a product.

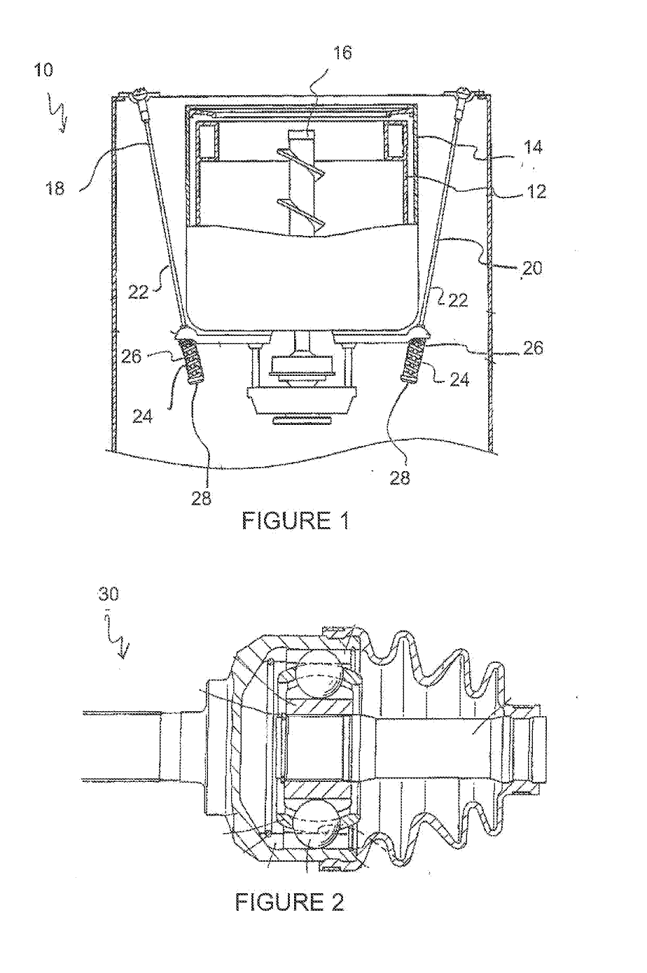

In one embodiment, for instance, the polymer composition may be used to produce a seal in a consumer appliance product or a motor vehicle, such as in a washing machine, a dryer, a motorcycle, or an automobile. Referring to FIG. 1, for instance, a cross-sectional view of a washing machine generally 10 is illustrated. In the embodiment shown, the washing machine 10 is an upright washing machine. As shown, the washing machine includes a drum 12 contained in a basket 14. The drum 12 is configured to hold articles of clothing and other materials during the washing process. As shown, the washing machine 10 further includes an agitator 16.

The washing machine 10 further includes a suspension system that includes a pair of suspension devices 18 and 20. The suspension system is designed to reduce vibration and maintain balance.

Each suspension device 18 and 20 includes rods 22 that are connected to springs 24. The springs 24 are held within a piston 26 and terminate with a seal 28. In accordance with the present disclosure, the seals 28 can be made from the thermoplastic elastomer composition of the present disclosure.

Referring to FIG. 2, a connection device 30 is illustrated that may be used in numerous applications. For instance, the connection device 30 may be used in a vehicle for attaching a wheel to a frame. In one embodiment, the connection device 30 comprises a homokinetic joint. The homokinetic joint can include various seals that may be made from the thermoplastic elastomer composition of the present disclosure. As will be explained in greater detail below, the thermoplastic composition of the present disclosure provides for better wear resistance over a broader temperature range which may be particularly beneficial when used in a vehicle.

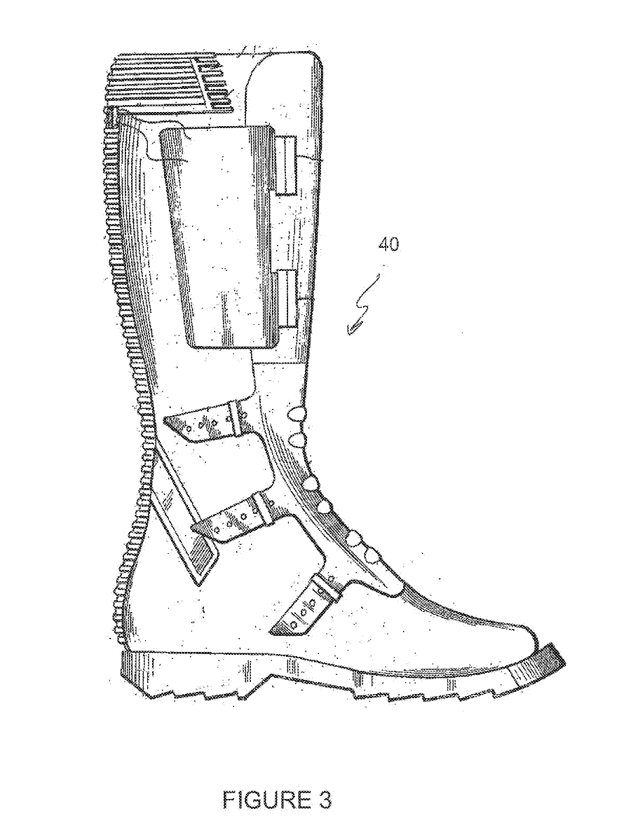

In yet another embodiment, the polymer composition of the present disclosure may be used to produce articles of clothing. For instance, in FIG. 3, a boot 40 is shown that may be made from the polymer composition. In one embodiment, for instance, the polymer composition can be injection molded for forming one or more layers and/or one or more components of the boot 40. The boot 40 may comprise, for instance, a motorcycle boot, a ski boot, or the like.

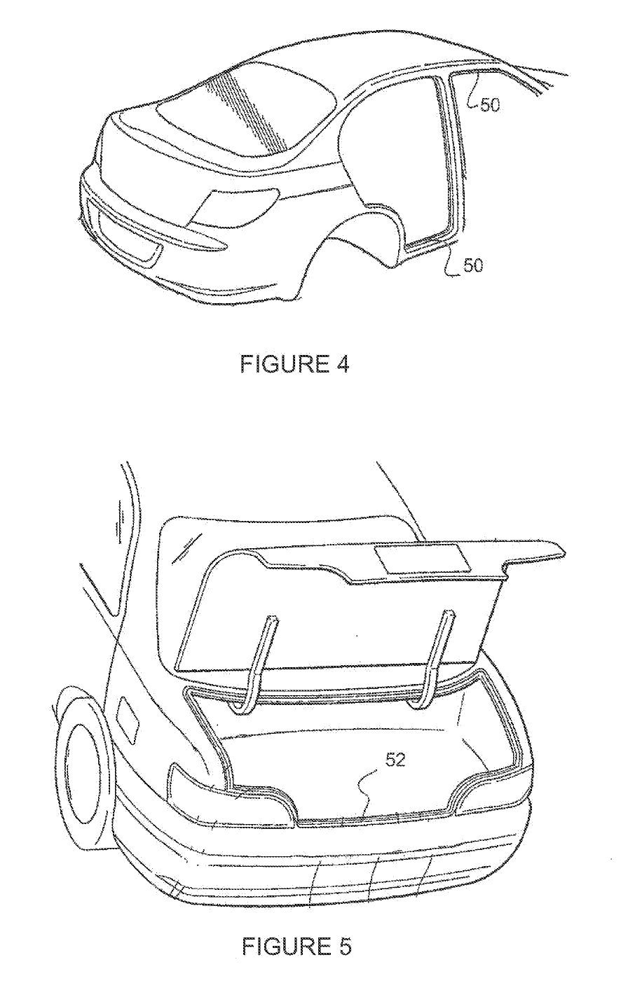

The polymer composition of the present disclosure is also well suited for producing various gaskets and seals that may be needed around openings. For instance, referring to FIGS. 4 and 5, portions of an automobile are shown. In FIG. 4, the automobile includes doorway openings that are surrounded by a gasket 50 that may be made in accordance with the present disclosure. In FIG. 5, the trunk of an automobile is shown that also includes a gasket 52 made in accordance with the present disclosure.

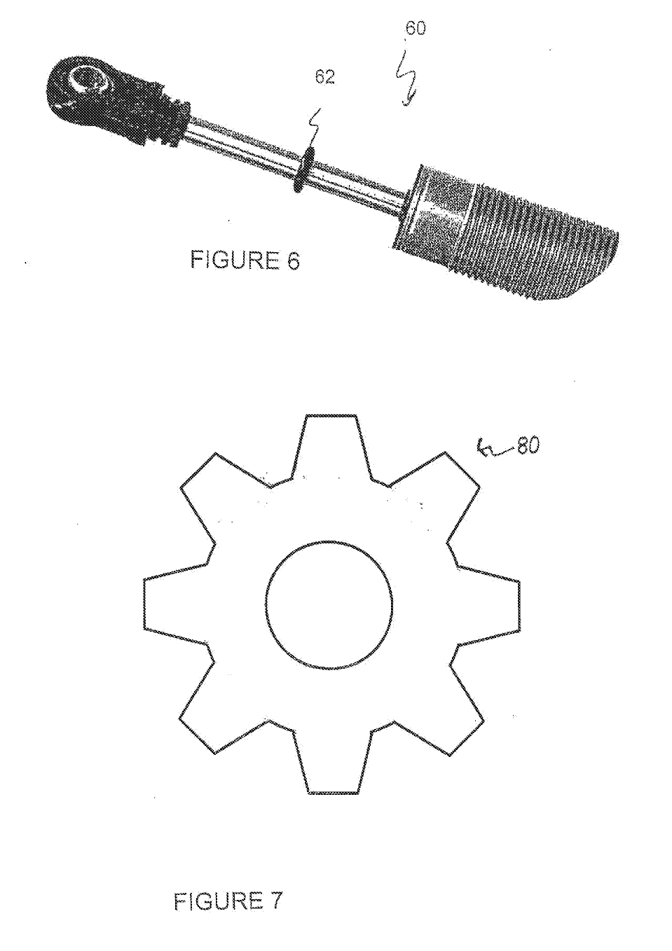

Referring to FIG. 6, a shock absorber 60 is illustrated. The shock absorber 60, for instance, may be made for a motorized vehicle such as an automobile or motorcycle, or for a bicycle. In accordance with the present disclosure, the shock absorber 60 may include one or more seal rings 62 that are made from the polymer composition of the present disclosure.

The polymer composition of the present disclosure is also well suited for producing gears. For instance, referring to FIG. 7, a gear 80 is shown made in accordance with the present disclosure. In particular, the gears may be used for low noise applications such as cameras and toys.

As described above, the polymer composition of the present disclosure generally contains a thermoplastic elastomer combined with a wear resistant additive. In one embodiment, the thermoplastic elastomer may comprise a thermoplastic polyester elastomer.

For example, the polymer composition may contain a copolyester elastomer such as a segmented thermoplastic copolyester. The thermoplastic polyester elastomer, for example, may comprise a multi-block copolymer. Useful segmented thermoplastic copolyester elastomers include a multiplicity of recurring long chain ester units and short chain ester units joined head to tail through ester linkages. The long chain units can be represented by the formula

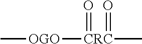

and the short chain units can be represented by the formula

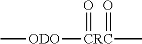

where G is a divalent radical remaining after the removal of the terminal hydroxyl groups from a long chain polymeric glycol having a number average molecular weight in the range from about 600 to 6,000 and a melting point below about 55° C., R is a hydrocarbon radical remaining after removal of the carboxyl groups from dicarboxylic acid having a molecular weight less than about 300, and D is a divalent radical remaining after removal of hydroxyl groups from low molecular weight diols having a molecular weight less than about 250.

The short chain ester units in the copolyetherester provide about 25 to 95% of the weight of the copolyetherester, and about 50 to 100% of the short chain ester units in the copolyetherester are identical.

The term “long chain ester units” refers to the reaction product of a long chain glycol with a dicarboxylic acid. The long chain glycols are polymeric glycols having terminal (or nearly terminal as possible) hydroxy groups, a molecular weight above about 600, such as from about 600-6000, a melting point less than about 55° C. and a carbon to oxygen ratio about 2.0 or greater. The long chain glycols are generally poly(alkylene oxide)glycols or glycol esters of poly(alkylene oxide)dicarboxylic acids. Any substituent groups can be present which do not interfere with polymerization of the compound with glycol(s) or dicarboxylic acid(s), as the case may be. The hydroxy functional groups of the long chain glycols which react to form the copolyesters can be terminal groups to the extent possible. The terminal hydroxy groups can be placed on end capping glycol units different from the chain, i.e., ethylene oxide end groups on poly(propylene oxide glycol).

The term “short chain ester units” refers to low molecular weight compounds or polymer chain units having molecular weights less than about 550. They are made by reacting a low molecular weight diol (below about 250) with a dicarboxylic acid.

The dicarboxylic acids may include the condensation polymerization equivalents of dicarboxylic acids, that is, their esters or ester-forming derivatives such as acid chlorides and anhydrides, or other derivatives which behave substantially like dicarboxylic acids in a polymerization reaction with a glycol.

The dicarboxylic acid monomers for the elastomer have a molecular weight less than about 300. They can be aromatic, aliphatic or cycloaliphatic. The dicarboxylic acids can contain any substituent groups or combination thereof which do not interfere with the polymerization reaction. Representative dicarboxylic acids include terephthalic and isophthalic acids, bibenzoic acid, substituted dicarboxy compounds with benzene nuclei such as bis(p-carboxyphenyl) methane, p-oxy-(p-carboxyphenyl)benzoic acid, ethylene-bis(p-oxybenzoic acid), 1,5-naphthalene dicarboxylic acid, 2,6-naphthalene dicarboxylic acid, 2,7-naphthalene dicarboxylic acid, phenanthralenedicarboxylic acid, anthralenedicarboxylic acid, 4,4′-sulfonyl dibenzoic acid, etc. and C₁-C₁₀ alkyl and other ring substitution derivatives thereof such as halo, alkoxy or aryl derivatives. Hydroxy acids such as p(β-hydroxyethoxy)benzoic acid can also be used providing an aromatic dicarboxylic acid is also present.

Representative aliphatic and cycloaliphatic acids are sebacic acid, 1,3- or 1,4-cyclohexane dicarboxylic acid, adipic acid, glutaric acid, succinic acid, carbonic acid, oxalic acid, itaconic acid, azelaic acid, diethylmalonic acid, fumaric acid, citraconic acid, allylmalonate acid, 4-cyclohexene-1,2-dicarboxylate acid, pimelic acid, suberic acid, 2,5-diethyladipic acid, 2-ethylsuberic acid, 2,2,3,3-tetramethylsuccinic acid, cyclopentanedicarboxylic acid, decahydro-1,5- (or 2,6-) naphthylenedicarboxylic acid, 4,4′-bicyclohexyl dicarboxylic acid, 4,4′-methylenebis(cyclohexyl carboxylic acid), 3,4-furan dicarboxylate, and 1,1-cyclobutane dicarboxylate. The preferred aliphatic acids, are the cyclohexanedicarboxylic acids and adipic acid.

The dicarboxylic acid may have a molecular weight less than about 300. In one embodiment, phenylene dicarboxylic acids are used such as terephthalic and isophthalic acid.

Included among the low molecular weight (less than about 250) dials which react to form short chain ester units of the copolyesters are acyclic, alicyclic and aromatic dihydroxy compounds. Included are diols with 2-15 carbon atoms such as ethylene, propylene, isobutylene, tetramethylene, pentamethylene, 2,2-dimethyltrimethylene, hexamethylene and decamethylene glycols, dihydroxy cyclohexane, cyclohexane dimethanol, resorcinol, hydroquinone, 1,5-dihydroxy naphthalene, etc. Also included are aliphatic diols containing 2-8 carbon atoms. Included among the bis-phenols which can be used are bis(p-hydroxy)diphenyl, bis(p-hydroxyphenyl) methane, and bis(p-hydroxyphenyl) propane. Equivalent ester-forming derivatives of diols are also useful (e.g., ethylene oxide or ethylene carbonate can be used in place of ethylene glycol). Low molecular weight diols also include such equivalent ester-forming derivatives.

Long chain glycols which can be used in preparing the polymers include the poly(alkylene oxide)glycols such as polyethylene glycol, poly(1,2- and 1,3-propylene oxide)glycol, poly(tetramethylene oxide)glycol, poly(pentamethylene oxide)glycol, poly(hexamethylene oxide)glycol, poly(heptamethylene oxide)glycol, poly(octamethylene oxide)glycol, poly(nonamethylene oxide)glycol and poly(1,2-butylene oxide)glycol; random and block copolymers of ethylene oxide and 1,2-propylene oxide and poly-formals prepared by reacting formaldehyde with glycols, such as pentamethylene glycol, or mixtures of glycols, such as a mixture of tetramethylene and pentamethylene glycols.

In addition, the dicarboxymethyl acids of poly(alkylene oxides) such as the one derived from polytetramethylene oxide HOOCCH₂(OCH₂CH₂CH₂CH₂),(OCH₂COOH IV can be used to form long chain glycols in situ. Polythioether glycols and polyester glycols also provide useful products. In using polyester glycols, care must generally be exercised to control a tendency to interchange during melt polymerization, but certain sterically hindered polyesters, e.g., poly(2,2-dimethyl-1,3-propylene adipate), poly(2,2-dimethyl-1,3-propylene/2-methyl-2-ethyl-1,3-propylene 2,5-dimethylterephthalate), poly(2,2-dimethyl-1,3-propylene/2,2-diethyl-1,3-propylene, 1,4cyclohexanedicarboxylate) and poly(1,2-cyclohexylenedimethylene/2,2-dimethyl-1,3-propylene 1,4-cyclohexanedicarboxylate) can be utilized under normal reaction conditions and other more reactive polyester glycols can be used if a short residence time is employed. Either polybutadiene or polyisoprene glycols, copolymers of these and saturated hydrogenation products of these materials are also satisfactory long chain polymeric glycols. In addition, the glycol esters of dicarboxylic acids formed by oxidation of polyisobutylenediene copolymers are useful raw materials.

Although the long chain dicarboxylic acids (IV) above can be added to the polymerization reaction mixture as acids, they react with the low molecular weight diols(s) present, these always being in excess, to form the corresponding poly(alkylene oxide) ester glycols which then polymerize to form the G units in the polymer chain, these particular G units having the structure

-DOCCH₂(OCH₂CH₂CH₂CH₂)ₓOCH₂COODO

when only one low molecular weight dial (corresponding to D) is employed. When more than one diol is used, there can be a different diol cap at each end of the polymer chain units. Such dicarboxylic acids may also react with long chain glycols if they are present, in which case a material is obtained having a formula the same as V above except the Ds are replaced with polymeric residues of the long chain glycols. The extent to which this reaction occurs is quite small, however, since the low molecular weight diol is present in considerable molar excess.

In place of a single low molecular weight diol, a mixture of such diols can be used. In place of a single long chain glycol or equivalent, a mixture of such compounds can be utilized, and in place of a single low molecular weight dicarboxylic acid or its equivalent, a mixture of two or more can be used in preparing the thermoplastic copolyester elastomers which can be employed in the compositions of this invention. Thus, the letter “G” in Formula II above can represent the residue of a single long chain glycol or the residue of several different glycols, the letter D in Formula III can represent the residue of one or several low molecular weight dials and the letter R in Formulas II and III can represent the residue of one or several dicarboxylic acids. When an aliphatic acid is used which contains a mixture of geometric isomers, such as the cis-trans isomers of cyclohexane dicarboxylic acid, the different isomers should be considered as different compounds forming different short chain ester units with the same diol in the copolyesters. The copolyester elastomer can be made by conventional ester interchange reaction.

As described above, the hardness of the thermoplastic elastomer can be varied by varying the amount of hard segments and soft segments. For instance, the thermoplastic elastomer can generally have a hardness of greater than about 30 Shore D, such as greater than about 50 Shore D, such as greater than about 65 Shore D. The hardness is generally less than about 90 Shore D, such as less than about 85 Shore D, such as less than about 80 Shore D. In one embodiment, a thermoplastic polyester elastomer is used that has a Shore D hardness of from about 60 to about 65. In an alternative embodiment, a thermoplastic elastomer may be used that has a Shore D hardness of from about 75 to about 80.

Copolyether esters with alternating, random-length sequences of either long chain or short chain oxyalkalene glycols can contain repeating high melting blocks that are capable of crystallization and substantially amorphous blocks with a relatively low glass transition temperature. In one embodiment, the hard segments can be composed of tetramethylene terephthalate units and the soft segments may be derived from aliphatic polyether and polyester glycols. Of particular advantage, the above materials resist deformation at surface temperatures because of the presence of a network of microcrystallites formed by partial crystallization of the hard segments. The ratio of hard to soft segments determines the characteristics of the material. Thus, another advantage to thermoplastic polyester elastomers is that soft elastomers and hard elastoplastics can be produced by changing the ratio of the hard and soft segments.

In one particular embodiment, the polyester thermoplastic elastomer has the following formula: -[4GT]_{X}[BT]_{y}, wherein 4G is butylene glycol, such as 1,4-butane diol, B is poly(tetramethylene ether glycol) and T is terephthalate, and wherein x is from about 0.60 to about 0.99 and y is from about 0.01 to about 0.40,

In accordance with the present disclosure, the thermoplastic polyester elastomer is combined with a wear resistant additive. In general, the thermoplastic elastomer is present in the polymer composition in an amount of at least about 60% by weight, such as in an amount of at least about 70% by weight, such as in an amount of at least about 80% by weight. The thermoplastic elastomer is generally present in an amount less than about 98% by weight, such as in an amount less than about 95% by weight. The abrasion resistant additive, on the other hand, is generally present in the polymer composition in an amount greater than about 2% by weight, such as in an amount greater than about 3% by weight, such as in an amount greater than about 4% by weight. The abrasion resistant additive is present in the composition in an amount generally less than about 20% by weight, such as in an amount less than about 18% by weight, such as in an amount less than about 15% by weight, such as in an amount less than about 12% by weight.

The abrasion resistant additive may comprise, for instance, particles that not only increase wear resistance but do so without significantly affecting the properties of the thermoplastic elastomer. In one embodiment, the particles may comprise a fluoropolymer. In one embodiment, the particles may comprise an ultra-high molecular weight polyolefin, such as ultra-high molecular weight polyethylene particles. In one embodiment, the particles may comprise a fluoropolymer and an ultra-high molecular weight polyolefin.

In one embodiment, the ultra-high molecular weight polyethylene particles may remain unmodified. In one embodiment, the ultra-high molecular weight polyethylene particles may be modified such as surface treated so as to include functional groups. By surface treating the particles, interfacial bonding may occur between the particles and the thermoplastic elastomer, particularly the thermoplastic polyester elastomer.

In one embodiment, the surface treatment may produce a functionalized ultra-high molecular weight polyethylene. For example, an exemplary surface treatment method is plasma treatment. The functionalized polyethylene comprises homo- or copolymers of ethylene. According to a further embodiment at least 50 mol-%, preferably at least 60 mol-%, more preferably at least 70 mol-% or at least 80 mol-%, especially at least 90 mol-%, at least 95 mol-%, in particular at least 97 mol-% or at least 98.5 mol-% of the total monomer units are ethylene.

In general the surface of the ultrahigh molecular weight polyethylene (UHMW-PE) is functionalized by oxidation of the surface. A typical process is the plasma treatment of the surface. According to one embodiment, the functionalized ultrahigh molecular weight polyethylene is obtainable or obtained by a plasma treatment of a ultrahigh molecular weight polyethylene. The functionalized UHMW-PE surface may comprise groups selected from the group —OH (Hydroxy), —OOH (Hydroperoxo), —NH₂ (Amino), —COOH (Carboxyl), —COOOH (Peracid), —CHO (Aldehyde), etc. The degree of hydrophilization or the number of functional groups present on the surface of the UHMW-PE can be adjusted by the time and the conditions of the treatment as well as the particle size of the UHMW-PE.

Methods to obtain functionalized UHMW-PE are described in U.S. Pat. No. 6,616,918 B and U.S. Pat. No. 5,977,299 A which are herein incorporated by reference.

In one embodiment, the hydrophobic surface of an ultrahigh molecular weight polyethylene is treated with a mixture comprising 1 to 99.9% by weight of at least one water soluble wetting agent and 0.1 to 99% by weight of at least one water insoluble wetting agent. Preferably, a water soluble alkane sulfonate and polyglycol ether, such as polypropylene glycol monobutyl ether is used.

In a further embodiment the surface of the UHMW-PE can be functionalized by reacting the surface of the UHMW-PE with a monomer comprising an unsaturated group and which is capable of reacting with the surface and attaching polyethylene glycol or polypropylene glycol to the modified surface.

The unsaturated monomer can be reacted with the surface by irradiation, i.e. with an electron beam.

The functionalized UHMW-PE may further be characterized by having an acid number of from about more than 0.5 mg KOH/g, preferably about more than 1.0 mg KOH/g, further preferably about 1.5 to about 20 mg KOH/g according to ASTM D 1386. The acid number may provide a measure of the extent of hydrophilization or oxidation of the UHMW-PE.

The functionalized UHMW-PE may be in the form of a powder, such as a micro powder. The functionalized UHMW-PE generally has a mean particle diameter D₅₀ (volume based and determined by light scattering) in the range of 1 to 500 μm.

According to one embodiment, the functionalized ultrahigh molecular weight polyethylene has a mean particle diameter D₅₀ ranging from 20 to 120 μm.

In one embodiment, the mean particle diameter of the ultrahigh molecular weight polyethylene is less than about 80 microns, such as less than about 70 microns, such as less than about 60 microns, such as less than about 50 microns. For example, in one embodiment, the mean particle diameter can be from about 20 microns to about 50 microns, such as from about 20 microns to about 40 microns.

The ultrahigh molecular weight polyethylene particles can also have a spherical shape or an irregular shape. As used herein, an irregular shape refers to a particle that is non-spherical and may contain lobes and/or hills and valleys. For instance, the particles may have a popcorn-like shape. In one embodiment, irregular-shaped particles are incorporated into the polymer composition. Better physical and mechanical bonding with the polymer matrix may occur when using irregular-shaped particles which allows for increased abrasion resistance while minimizing any adverse effects on the properties of the elastomer.

In one embodiment, the abrasion resistant additive may comprise a fluoropolymer. The fluoropolymer may comprise a polytetrafluoroethylene. The fluoropolymer may be present in a granular, powder, or fiber form. The fluoropolymer may have an average bulk density of from about 100 to about 800 g/L, such as from about 200 to about 600 g/L, such as from about 300 to about 500 g/L according to ASTM D4894. The fluoropolymer may have an average particle size distribution of from about 2 μm to about 20 μm, such as from about 5 μm to about 15 μm, such as from about 7 μm to about 12 μm. The fluoropolymer may have a specific surface area of at least 0.5 m²/g, such as at least 1m²/g, such as at least 2 m²/g, such as at least 5 m²/g, such as at least 8 m²/g, such as at least 10 m²/g, such as at least 15 m²/g but less than about 100 m²/g, such as less than about 50 m²/g, such as less than about 20 m²/g, such as less than about 15 m²/g, such as less than about 12 m²/g, such as less than about 10 m²/g, such as less than about 5 m²/g.

The abrasion resistant additive can have an average molecular weight of higher than about 1.0·10⁶ g/mol, such as higher than about 2.0·10⁶ g/mol, such as higher than about 4.0·10⁶ g/mol, especially having an average molecular weight ranging from about 1.0·10⁶ g/mol to about 15.0·10⁶ g/mol, such as ranging from about 3.0·10⁶ g/mol to about 12.0·10⁶ g/mol, determined by viscosimetry. Molecular weight may be calculated by way of the Mark-Houwink equation if so desired.

The viscosity number of the abrasion resistant additive can be higher than 1000 ml/g, such as higher than 1500 ml/g, especially ranging from 1800 ml/g to 5000 ml/g, such as ranging from 2000 ml/g to 4300 ml/g (determined according to ISO 1628, part 3; concentration in decahydronaphthalin: 0.0002 g/ml).

In one embodiment, the polymer composition may also contain a reactive modifier. For instance, a reactive modifier may be used that reacts with the surface of the ultrahigh molecular weight polyethylene particles and may also react with the thermoplastic elastomer. In this manner, the ultrahigh molecular weight polyethylene particles are further integrated into the polymer matrix and thus offer improved abrasion resistance without adversely affecting other properties.

In one embodiment, the reactive modifier can be an ethylene copolymer or terpolymer or an ethylene propylene copolymer or terpolymer. By way of example, the non-aromatic reactive modifier can include ethylenically unsaturated monomer units have from about 4 to about 10 carbon atoms. In addition, the non-aromatic reactive modifier can be modified with a mole fraction of from about 0.01 to about 0.5 of one or more of the following: an α, β unsaturated dicarboxylic acid or salt thereof having from about 3 to about 8 carbon atoms; an α, β unsaturated carboxylic acid or salt thereof having from about 3 to about 8 carbon atoms; an anhydride or salt thereof having from about 3 to about 8 carbon atoms; a monoester or salt thereof having from about 3 to about 8 carbon atoms; a sulphonic acid or a salt thereof; an unsaturated epoxy compound having from about 4 to about 11 carbon atoms. Examples of such modification functionalities include maleic anhydride, fumaric acid, maleic acid, methacrylic acid, acrylic acid, and glycidyl methacrylate. Examples of metallic acid salts include the alkaline metal and transitional metal salts such as sodium, zinc, and aluminum salts.

A non-limiting listing of such non-aromatic reactive modifiers that may be used include ethylene-acrylic acid copolymer, ethylene-maleic anhydride copolymers, ethylene-alkyl(meth)acrylate-maleic anhydride terpolymers, ethylene-alkyl(meth)acrylate-glycidyl (meth)acrylate terpolymers, ethylene-acrylic ester-methacrylic acid terpolymer, ethylene-acrylic ester-maleic anhydride terpolymer, ethylene-methacrylic acid-methacrylic acid alkaline metal salt (ionomer) terpolymers, etc. In one embodiment, for instance, the reactive modifier can be a random terpolymer of ethylene, methylacrylate, and glycidyl methacrylate. The terpolymer can have a glycidyl methacrylate content of from about 5% to about 20%, such as from about 6% to about 10%. The terpolymer may have a methylacrylate content of from about 20% to about 30%, such as about 24%.

The reactive modifier may be linear or branched, may be a homopolymer or copolymer (e.g., random, graft, block, etc.), and may contain epoxy functionalization in any portion of the polymer, e.g., terminal epoxy groups, skeletal oxirane units, and/or pendent epoxy groups. For instance, the reactive modifier may be a copolymer including at least one monomer component that includes epoxy functionalization. The monomer units of the reactive modifier may vary. In one embodiment, for example, the reactive modifier can include epoxy-functional methacrylic monomer units. As used herein, the term methacrylic generally refers to both acrylic and methacrylic monomers, as well as salts and esters thereof, e.g., acrylate and methacrylate monomers. Epoxy-functional methacrylic monomers as may be incorporated in the reactive modifier may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate.

Other monomer units may additionally or alternatively be a component of the reactive modifier. Examples of other monomers may include, for example, ester monomers, olefin monomers, amide monomers, etc. In one embodiment, the non-aromatic reactive modifier can include at least one linear or branched α-olefin monomer, such as those having from 2 to 20 carbon atoms, or from 2 to 8 carbon atoms. Specific examples include ethylene; propylene; 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene.

Monomers included in a reactive modifier that includes epoxy functionalization can include monomers that do not include epoxy functionalization, as long as at least a portion of the monomer units of the polymer are epoxy functionalized.

In one embodiment, the reactive modifier can be a terpolymer that includes epoxy functionalization. For instance, the reactive modifier can include a methacrylic component that includes epoxy functionalization, an α-olefin component, and a methacrylic component that does not include epoxy functionalization. For example, the reactive modifier may be poly(ethylene-co-methylacrylate-co-glycidyl methacrylate), which has the following structure:

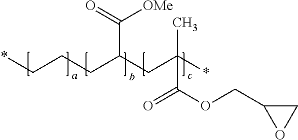

wherein, a, b, and c are 1 or greater.

The relative proportion of the various monomer components of a copolymeric reactive modifier is not particularly limited. For instance, in one embodiment, the epoxy-functional methacrylic monomer components can form from about 1 wt. % to about 25 wt, %, or from about 2 wt. % to about 20 wt % of a copolymeric non-aromatic reactive modifier. An -olefin monomer can form from about 55 wt. % to about 95 wt. %, or from about 60 wt. % to about 90 wt. %, of a copolymeric non-aromatic reactive modifier. When employed, other monomeric components (e.g., a non-epoxy functional methacrylic monomers) may constitute from about 5 wt. % to about 35 wt. %, or from about 8 wt. % to about 30 wt. %, of a compolymeric non-aromatic reactive modifier.

A reactive modifier may be formed according to standard polymerization methods as are generally known in the art. For example, a monomer containing polar functional groups may be grafted onto a polymer backbone to form a graft copolymer. Alternatively, a monomer containing functional groups may be copolymerized with a monomer to form a block or random copolymer using known free radical polymerization techniques, such as high pressure reactions, Ziegler-Natta catalyst reaction systems, single site catalyst (e.g., metallocene) reaction systems, etc.

When present, the reactive modifier can be included in the polymer composition in an amount less than about 8% by weight, such as in an amount less than about 6% by weight, such as in an amount of less than about 4% by weight. When present, the reactive modifier may be included in the polymer composition in an amount greater than about 0.5% by weight, such as in an amount greater than about 1% by weight.

In addition to the above components, the polymer composition may include various other ingredients. Colorants that may be used include any desired inorganic pigments, such as titanium dioxide, ultramarine blue, cobalt blue, and other organic pigments and dyes, such as phthalocyanines, anthraquinones, and the like. Other colorants include carbon black or various other polymer-soluble dyes. The colorants can generally be present in the composition in an amount up to about 2 percent by weight.

Still another additive that may be present in the composition is an antioxidant, such as a sterically hindered phenol compound. Examples of such compounds, which are available commercially, are pentaerythrityl tetrakis[3-(3,5-di-tert-butyl-4-hydroxyphenyl)propionate] (Irganox 1010, BASF), triethylene glycol bis[3-(3-tert-butyl-4-hydroxy-5-methylphenyl)propionate] (Irganox 245, BASF), 3,3′-bis[3-(3,5-di-tert-butyl-4-hydroxyphenyl)propionohydrazide] (Irganox MD 1024, BASF), hexamethylene glycol bis[3-(3,5-di-tert-butyl-4-hydroxyphenyl)propionate] (Irganox 259, BASF), and 3,5-di-tert-butyl-4-hydroxytoluene (Lowinox BHT, Chemtura). In one embodiment, for instance, the antioxidant comprises tetrakis[methylene(3,5-di-tert-butyl-4-hydroxyhydrocinnamate)]methane. The antioxidant may be present in the composition in an amount less than 2% by weight, such as in an amount from about 0.1 to about 1.5% by weight.

Light stabilizers that may be present in the composition include sterically hindered amines. Such compounds include 2,2,6,6-tetramethyl-4-piperidyl compounds, e.g., bis(2,2,6,6-tetramethyl-4-piperidyl)sebacate (Tinuvin 770, BASF) or the polymer of dimethyl succinate and 1-(2-hydroxyethyl)-4-hydroxy-2,2,6,6-tetramethyl-4-piperidine (Tinuvin 622, BASF). UV stabilizers or absorbers that may be present in the composition include benzophenones or benzotriazoles.

Fillers that may be included in the composition include glass beads, wollastonite, loam, molybdenum disulfide or graphite, inorganic or organic fibers such as glass fibers, carbon fibers or aramid fibers. The glass fibers, for instance, may have a length of greater than about 3 mm, such as from 5 to about 50 mm.

Various other stabilizers may also be present in the composition. For instance, in one embodiment, the composition may contain a phosphite, such as a diphosphite. For instance, in one embodiment, the phosphite compound may comprise distearyl pentaerythritol diphosphite. The phosphite compound may also comprise bis(2,4-ditert-butylphenyl)pentaerythritol diphosphite. An organophosphite processing stabilizer as described above may be present in the polymer composition in an amount less than about 2% by weight, such as in an amount from about 0.1% to about 1.5% by weight.

In order to produce molded articles in accordance with the present disclosure, the different components of the polymer composition can be dry blended together in a drum tumbler or in a high intensity mixer. The premixed blends can then be melt blended and extruded as pellets. The pellets can then be used in an injection molding process.

Articles, coatings, products and the like made in accordance with the present disclosure can have an excellent combination of physical properties. For instance, the articles can be abrasion resistant over a wide temperature range while also having the properties of a thermoplastic elastomer. For example, the polymer composition can have excellent abrasion resistance properties, when tested according to Taber Test H18 (1,000 cycles or 10,000 cycles). The abrasion resistance will depend upon the flexural modulus of the polymer composition. As described above, the flexural modulus is based upon the ratio of hard segments to soft segments in the thermoplastic elastomer.

The flexural modulus can vary widely depending upon the elastomer selected. For instance, the modulus can be less than about 500 MPa or greater than about 500 MPa. In general, the flexural modulus can be from about 100 MPa to about 1,300 MPa when tested at 23° C., such as from about 100 MPa to about 900 MPa. At a flexural modulus of less than about 400 MPa, the polymer composition may have a taber abrasion resistance at 1,000 cycles of less than about 70 g, such as less than about 60 g. When the flexural modulus is greater than about 600, on the other hand, the taber abrasion resistance is generally less than about 40 g, such as less than about 30 g, such as less than about 25 g when tested at 1,000 cycles.

The present disclosure may be better understood with reference to the following example.

### Example

The following polymer compositions were formulated and dry blended together in a drum tumbler.

| | Control | Control | Control | Control | Sample | Sample | Sample | Sample | Sample |
|---|---|---|---|---|---|---|---|---|---|
| | No. 1 | No. 2 | No. 3 | No. 4 | No. 1 | No. 2 | No. 3 | No. 4 | No. 5 |
| | (wt. %) | (wt. %) | (wt. %) | (wt. %) | (wt. %) | (wt. %) | (wt. %) | (wt. %) | (wt. %) |
| Thermoplastic polyester | 100 | — | — | — | 94.5 | — | 89.5 | — | — |
| elastomer with 63 Shore | | | | | | | | | |
| D hardness | | | | | | | | | |
| Thermoplastic polyester | — | 100 | — | — | — | 94.5 | — | 89.5 | — |
| elastomer with 77 Shore | | | | | | | | | |
| D hardness | | | | | | | | | |
| Thermoplastic polyester | — | — | 100 | — | — | — | — | — | 79.5 |
| elastomer with 40 Shore | | | | | | | | | |
| D hardness | | | | | | | | | |
| Thermoplastic polyester | — | — | — | 100 | | | | | |
| elastomer with 55 Shore | | | | | | | | | |
| D hardness | | | | | | | | | |
| Tetrakis [methylene | — | — | — | — | 0.3 | 0.3 | 0.3 | 0.3 | 0.3 |
| (3,5-di-tert-butyl-4- | | | | | | | | | |
| hydroxyhydrocinnamate)] | | | | | | | | | |
| methane | | | | | | | | | |
| Bis(2,4-ditert- | — | — | — | — | 0.2 | 0.2 | 0.2 | 0.2 | 0.2 |
| butylphenyl) | | | | | | | | | |
| pentaerytritol diphosphite | | | | | | | | | |
| Unmodified ultrahigh | — | — | — | — | 5 | 5 | 10 | 10 | 20 |
| molecular weight | | | | | | | | | |
| polyethylene spherical | | | | | | | | | |
| particles (60 microns) | | | | | | | | | |

| | Sample | Sample | Sample | Sample | Sample | Sample | Sample | Sample | Sample | Sample |
|---|---|---|---|---|---|---|---|---|---|---|
| | No. 6 | No. 7 | No. 8 | No. 9 | No. 10 | No. 11 | No. 12 | No. 13 | No. 14 | No. 15 |
| | (wt. %) | (wt. %) | (wt. %) | (wt. %) | (wt. %) | (wt. %) | (wt. %) | (wt. %) | (wt. %) | (wt. %) |
| Thermoplastic polyester | 94.5 | 94.5 | — | — | — | — | 88.5 | 94.5 | — | — |
| elastomer with 63 Shore | | | | | | | | | | |
| D hardness | | | | | | | | | | |
| Thermoplastic polyester | — | — | — | — | — | — | — | — | 94.5 | 88.5 |
| elastomer with 77 Shore | | | | | | | | | | |
| D hardness | | | | | | | | | | |
| Thermoplastic polyester | — | — | — | — | — | — | — | — | — | — |
| elastomer with 40 Shore | | | | | | | | | | |
| D hardness | | | | | | | | | | |
| Thermoplastic polyester | — | — | 94.5 | 89.5 | 88.5 | 94.5 | — | — | — | — |
| elastomer with 55 Shore | | | | | | | | | | |
| D hardness | | | | | | | | | | |
| Tetrakis [methylene | 0.3 | 0.3 | 0.3 | 0.3 | 0.3 | 0.3 | 0.3 | 0.3 | 0.3 | 0.3 |
| (3,5-di-tert-butyl-4- | | | | | | | | | | |
| hydroxyhydrocinnamate)] | | | | | | | | | | |
| methane | | | | | | | | | | |
| Bis(2,4-ditert- | 0.2 | 0.2 | 0.2 | 0.2 | 0.2 | 0.2 | 0.2 | 0.2 | 0.2 | 0.2 |
| butylphenyl) | | | | | | | | | | |
| pentaerytritol | | | | | | | | | | |
| diphosphite | | | | | | | | | | |
| Unmodified | — | — | — | 10 | — | 2.5 | — | 2.5 | — | — |
| ultrahigh molecular | | | | | | | | | | |
| weight polyethylene | | | | | | | | | | |
| spherical particles | | | | | | | | | | |
| (60 microns) | | | | | | | | | | |
| Modified treated | — | — | — | — | 10 | — | 10 | — | — | 10 |
| ultrahigh molecular | | | | | | | | | | |
| weight polyethylene | | | | | | | | | | |
| spherical particles | | | | | | | | | | |
| (60 microns) | | | | | | | | | | |
| PTFE powder | 5 | — | 5 | — | — | 2.5 | — | 2.5 | 5 | |
| (average particle | | | | | | | | | | |
| size distribution of | | | | | | | | | | |
| 12 μm) | | | | | | | | | | |
| Polyethylene glycol | — | 5 | — | — | — | — | — | — | — | — |
| 35000, solidified | | | | | | | | | | |
| flakes | | | | | | | | | | |
| Ethylene and | — | — | — | — | 1 | — | 1 | — | — | 1 |
| glycidyl | | | | | | | | | | |
| methacrylate | | | | | | | | | | |
| random copolymer | | | | | | | | | | |

The premixed ingredients were melt-blended and extruded as pellets in a WLE-25 extruder having a SC-202 screw design under the following temperature settings:

| Barrel Zone | Temp. Setting (° C.) |
|---|---|
| 1 | 235-250 |
| 2 | 235-250 |
| 3 | 235-250 |
| 4 | 235-250 |
| 5 | 240-255 |
| 6 | 240-260 |
| Die head temp | 245 |
| Melt Temp | 265 |

The melt temperature was set at about 260° C. The screw speed was set at, for example 375 RPM with 50% torque. A typical die vacuum was 20 mm of Hg and throughput was 50 lbs/hr.

Each of the formulations was conventionally injection molded after drying of pellets at 120° C. for 4 hr. for example using a 4 oz. Demag 661 molding machine. The temperature settings were as follows:

| Zone | Temperature Setting (° C.) |
|---|---|
| Rear Barrel | 235-250 |
| Middle Barrel | 235-250 |
| Front Barrel | 240-255 |
| Nozzle | 240-260 |
| Melt | 235-260 |
| Moveable Mold | 30-50 |
| Stationary Mold | 30-50 |

The following results were obtained:

| | Control | Control | Control | Control | Sample | Sample | Sample | Sample | Sample |
|---|---|---|---|---|---|---|---|---|---|
| | No. 1 | No. 2 | No. 3 | No. 4 | No. 1 | No. 2 | No. 3 | No. 4 | No. 5 |
| | (wt. %) | (wt. %) | (wt. %) | (wt. %) | (wt. %) | (wt. %) | (wt. %) | (wt. %) | (wt. %) |
| Melt Flow Rate | 16 | 22 | 10 | 8 | 191 | 19.5 | 8.61 | 9.76 | 4.47 |
| (g/10 min) | (240° C./ | (250° C./ | (220° C./ | (220° C./ | (240° C./ | (250° C./ | (240° C./ | (250° C./ | (240° C./ |
| | 2.16 kg) | 2.16 kg) | 2.16 kg) | 2.16 kg) | 2.16 kg) | 2.16 kg) | 2.16 kg) | 2.16 kg) | 2.16 kg) |
| Flex Modulus | 360 | 750 | — | 205 | 257 | 732 | 284 | 764 | 102 |
| (23° C.) (MPa) | | | | | | | | | |
| Flex Modulus | — | — | — | — | 827 | 2428 | 701 | 2183 | 199 |
| (−20° C.) (MPa) | | | | | | | | | |
| Tensile Modulus | 360 | 1100 | — | 200 | 254 | 757 | 267 | 796 | 80 |
| (23° C.) (MPa) | | | | | | | | | |
| Tensile Strain- | 44 | 20 | — | — | 32 | 20 | 34.34 | 19.07 | 350.23 |
| yield (%) | | | | | | | | | |
| Tensile Stress- | 22 | 35 | — | — | 18 | 32 | 18.58 | 31.28 | 14.3 |
| yield (%) | | | | | | | | | |
| Notched Charpy | 105 | 9.4 | — | 65 | 94 | 6 | 41.4 | 5.1 | 35.7 |
| (23° C.) | | | | | | | | | |
| Notched Charpy | 22 | — | — | 150 | 13.1 | 2.7 | 7.2 | 2.5 | 33.4 |
| (−30° C.) | | | | | | | | | |
| Density (g/cm³) | 1.24 | 1.29 | — | 1.19 | — | — | — | — | — |
| Hardness | — | — | — | 55 | — | — | — | — | 40 |
| Shore D | | | | | | | | | |
| Deflection | — | — | — | — | 116.9 | 117.2 | — | — | — |
| Temperature | | | | | | | | | |
| Under Load | | | | | | | | | |
| (° C.) | | | | | | | | | |
| Taber-H18(1K) | 90.1 | 58.1 | — | 85 | 59.5 | 20.7 | 32.6 | 48.4 | 72.9 |
| (g) | | | | | | | | | |
| Taber-H18(10K) | 82.6 | 18.1 | — | — | 28.1 | 13.6 | 13.9 | 21.5 | 28.9 |
| (g) | | | | | | | | | |
| Tear Strength | — | — | — | 217 | — | — | — | — | — |
| (kN/m) | | | | | | | | | |

| | Sample | Sample | Sample | Sample | Sample | Sample | Sample | Sample | Sample | Sample |
|---|---|---|---|---|---|---|---|---|---|---|
| | No. 6 | No. 7 | No. 8 | No. 9 | No. 10 | No. 11 | No. 12 | No. 13 | No. 14 | No. 15 |
| | (wt. %) | (wt. %) | (wt. %) | (wt. %) | (wt. %) | (wt. %) | (wt. %) | (wt. %) | (wt. %) | (wt. %) |
| Melt Flow Rate | — | — | 9.67 | 7.57 | 5.35 | 9.11 | 8.29 | 14.84 | 19.27 | 11.08 |
| (g/10 min) | | | (220° C./ | (220° C./ | (220° C./ | (220° C./ | (240° C./ | (240° C./ | (250° C./ | (250° C./ |
| | | | 2.16 kg) | 2.16 kg) | 2.16 kg) | 2.16 kg) | 2.16 kg) | 2.16 kg) | 2.16 kg) | 2.16 kg) |
| Flex Modulus | 286 | 252 | 202 | 200 | 197 | 194 | 293 | 282 | 817 | 743 |
| (23° C.) (MPa) | | | | | | | | | | |
| Flex Modulus | — | — | — | — | — | — | — | — | — | — |
| (−20° C.) (MPa) | | | | | | | | | | |
| Tensile Modulus | 289 | 249 | 192 | 195 | 195 | 182 | 280 | 281 | 870 | 742 |
| (23° C.) (MPa) | | | | | | | | | | |
| Tensile Strain- | — | — | — | — | — | — | — | — | — | — |
| yield (%) | | | | | | | | | | |
| Tensile Stress- | — | — | — | — | — | — | — | — | — | — |
| yield (%) | | | | | | | | | | |
| Notched Charpy | 18.3 | 86.6 | 45.7 | 68 | 73.6 | 70.2 | 94.1 | 36 | 5.7 | 11.5 |
| (23° C.) | | | | | | | | | | |
| Notched Charpy | 8.5 | 14.6 | 17.3 | 74.6 | 116.5 | 31.7 | 15.3 | 11.2 | 3.8 | 3.9 |
| (−30° C.) | | | | | | | | | | |
| Density (g/cm³) | — | — | 1.217 | 1.16 | 1.156 | 1.194 | 1.179 | 1.221 | 1.304 | 1.217 |
| Hardness | — | — | 54.2 | 54.4 | 55.5 | 55.2 | 70.7 | 60 | 58.8 | 68.8 |
| Shore D | | | | | | | | | | |
| Deflection | — | — | 86.3 | 83.9 | 80 | 85.5 | 80.8 | 109 | 145 | 109 |
| Temperature | | | | | | | | | | |
| Under Load | | | | | | | | | | |
| (° C.) | | | | | | | | | | |
| Taber-H18(1K) | 15 | 38 | 25.5 | 56.3 | 21.7 | 53.3 | 49.1 | 23.6 | 8 | 32.4 |
| (g) | | | | | | | | | | |
| Taber-H18(10K) | 5 | 14.9 | 14.3 | 17.7 | 11.4 | 28.5 | 22.1 | 12.5 | 3.6 | 7.7 |
| (g) | | | | | | | | | | |
| Tear Strength | — | — | 208.7 | 212.3 | 173 | 164.6 | 160 | 147.5 | 160.7 | 141.3 |
| (kN/m) | | | | | | | | | | |

In the above tables, melt flow rate was determined according to ISO Test 1133. Flexural modulus was determined according to ISO Test 178, while the tensile tests were measured according to ISO Test 527. ISO Test 179 was used to determine notched Charpy results. ISO Test 75-11-2 was used to determine deflection temperature under load results. ASTM Test 0501 by Taber Abraser (Taber-H18) was used to determine the relative resistance to wear results. ISO Test 34 was used to determine tear strength.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A polymer composition comprising:
a thermoplastic polyester elastomer present in the composition in an amount sufficient to form a polymer matrix phase; and
a fluoropolymer, ultra-high molecular weight polyethylene particles, or a combination thereof, distributed throughout the matrix phase.

2. A polymer composition as defined in claim 1, wherein the ultra-high molecular weight polyethylene particles have a functionalized surface that produces interfacial bonding with the thermoplastic polyester elastomer.

3. A polymer composition as defined in claim 1, wherein the ultra-high molecular weight polyethylene particles have been plasma treated to produce functional groups on the surface thereof.

4. A polymer composition as defined in claim 1, wherein the functionalized surfaces of the ultra-high molecular weight polyethylene particles comprise hydroxyl groups, carboxyl groups, or mixtures thereof.

5. A polymer composition as defined in claim 1, wherein the ultra-high molecular weight polyethylene particles are present in the polymer composition in an amount from about 2% to about 12% by weight.

6. A polymer composition as defined in claim 1, wherein the ultra-high molecular weight polyethylene particles are present in the polymer composition in an amount from about 3% to about 8% by weight.

7. A polymer composition as defined in claim 5, wherein the thermoplastic polyester elastomer is present in the polymer composition in an amount from about 80% to about 98% by weight.

8. A polymer composition as defined in claim 1, wherein the polymer composition has a flexural modulus of from about 100 to about 1300 MPa at 23° C.

9. A polymer composition as defined in claim 1, wherein the ultra-high molecular weight polyethylene particles have a mean particle diameter of less than about 120 microns.

10. A polymer composition as defined in claim 1, wherein the ultra-high molecular weight polyethylene particles have a mean particle diameter of from about 10 microns to about 60 microns.

11. A polymer composition as defined in claim 9, wherein the ultra-high molecular weight polyethylene particles have a substantially spherical shape.

12. A polymer composition as defined in claim 9, wherein the ultra-high molecular weight polyethylene particles have an irregular shape.

13. A polymer composition as defined in claim 1, wherein the thermoplastic polyester elastomer contains soft segments and hard segments.

14. A polymer composition as defined in claim 13, wherein the thermoplastic polyester elastomer comprises a multi-block copolyester elastomer.

15. A polymer composition as defined in claim 13, wherein the hard segments comprise ester units and the soft segments comprise an aliphatic polyester or a polyester glycol.

16. A polymer composition as defined in claim 1, wherein the thermoplastic polyester elastomer has the following formula: -[4GT]ₓ[BT]_{y}, wherein 4G is 1,4-butane diol, B is poly(tetramethylene ether glycol) and T is terephthalate, and wherein x is about 0.6 to about 0.99 and y is about 0.01 to about 0.40.

17. A polymer composition as defined in claim 1, further containing a reactive modifier.

18. A polymer article comprising an elastic material comprising a polymer matrix phase comprised of a thermoplastic polyester elastomer, the matrix phase containing ultra-high molecular weight polyethylene particles dispersed therein, the ultra-high molecular weight polyethylene particles having a functionalized surface and wherein the ultra-high molecular weight polyethylene particles form an interfacial bond with the matrix phase, and wherein the material has a flexural modulus of from about 100 MPa to about 900 MPa @ 23° C.

19. A polymer article as defined in claim 18, wherein the elastic material comprises a polymer coating covering at least one surface of a shaped member.

20. A polymer article as defined in claim 19, wherein the shaped member comprises an article of clothing.

21. A polymer article as defined in claim 18, wherein the polymer article comprises a gasket, a seal, a washer, a gear, a pulley, or a conveyor belt segment.

22. A polymer article as defined in claim 18, wherein the ultra-high molecular weight polyethylene particles are present in the elastic material in an amount from about 2% to about 12% by weight, the ultra-high molecular weight polyethylene particles having been plasma treated, the elastic material containing the thermoplastic polyester elastomer in an amount of from about 80% to about 98% by weight.

23. A polymer article as defined in claim 18, wherein the thermoplastic polyester elastomer has the following formula: -[4GT]ₓ[BT]_{y}, wherein 4G is 1,4-butane diol, B is poly(tetramethylene ether glycol) and T is terephthalate, and wherein x is about 0.6 to about 0.99 and y is about 0.01 to about 0.40.

24. A polymer article as defined in claim 1, wherein the polymer article comprises a boot.
